(19) United States
(12) Patent Application Publication
(10) Pub. No.: US 2014/0126892 A1
(43) Pub. Date: May 8, 2014

(54) AROMA DIFFUSER HAVING A VARIABLE PLUGGING DEVICE USING AN AROMA CAPSULE

(71) Applicant: SERENE HOUSE INTERNATIONAL ENTERPRISE LTD., Road Town (VG)

(72) Inventor: Ming Jen Hsiao, Miaoli County (TW)

(73) Assignee: SERENE HOUSE INTERNATIONAL ENTERPRISE LTD., Road Town (VG)

(21) Appl. No.: 13/669,402

(22) Filed: Nov. 5, 2012

(51) Int. Cl. B05B 1/24

(52) U.S. Cl. 392/394

(57) ABSTRACT

An aroma diffuser is provided, including: a diffuser having a hollow housing, a heat conduction container, a resistor, and a plugging device, wherein the heat conduction container is disposed in the hollow housing, the resistor is disposed under the heat conduction container, and the plugging device is installed in the second opening of the hollow housing and electrically connected to the resistor; and a disposable aroma capsule disposed in the heat conduction container. The plugging device is a car plug that can be combined with an aroma material used in a car; or a USB device that can be combined with a mobile device, a notebook computer, a desktop computer or any appliance with a USB connection port. When supplied with power, the resistor generates heat, and the heat conduction container conducts the heat to the disposable container and the aroma material for the aroma material to diffuse scent.

### CROSS-REFERENCES TO RELATED APPLICATION

Two pending new application Ser. Nos. 13/543,490 and 13/549,493 filed on Jul. 15, 2012 are hereby incorporated by reference.

### BACKGROUND OF THE INVENTION

1. Field of the Invention

This invention relates to aroma diffusers, and, more particularly, to an aroma diffuser having a variable plugging device using an aroma capsule.

2. Description of Related Art

U.S. Pat. Nos. 8,066,420, 8,262,277 and 8,147,116 disclose an aroma diffuser, which includes a power supply, a lamp, and essential oil or aroma wax. The aroma diffuser has a complicated mechanical structure and a high manufacturing cost. A user needs to prepare a certain container for the aroma wax to be contained therein. The user also needs to take the aroma wax out from the container carefully and place the aroma wax in a ceramic receiving trough above a support stand, for the aroma wax to be heated by a light bulb of the lamp. When taking the aroma wax out from the container, the user is likely to be stained with the aroma wax. After the aroma material is evaporated completely, the user has to wash and clean the receiving trough. If the receiving trough is not sufficiently clean and another aroma material that disperses different scent from the previous aroma material is placed in the receiving trough, the user will smell unexpected, mixed scent. The receiving trough is made of a fragile material (e.g., a ceramic product), and is likely to be broken when being washed.

However, the aroma diffuser cannot be supplied with other sources of power, such as the power supplied by a car or a mobile device, and cannot be taken with the user anywhere.

### SUMMARY OF THE INVENTION

In view of the problems of the prior art, the present invention provides an aroma diffuser having a variable plugging device using an aroma capsule. The aroma diffuser may include a car plug or a USB device, and can be supplied with power from different sources. The aroma capsule is disposable. Therefore, a user does not need to wash a receiving trough or worry about breaking the receiving trough. The aroma diffuser is thus safe and easy to use.

In an embodiment, the aroma diffuser comprises: a diffuser including a hollow housing, a heat conduction container, a resistor, and a plugging device, wherein the hollow housing has a first opening and a second opening, the heat conduction container is received in the hollow housing and has a free end, the resistor is disposed under the heat conduction container, and the plugging device is installed in the second opening of the hollow housing and electrically connected to the resistor; and an aroma capsule disposed in the heat conduction container and comprising a disposable container and an aroma material disposed in the disposable container, the disposable container having an opening, wherein the resistor, when supplied with power, generates heat, and the heat conduction container conducts the heat to the disposable container and the aroma material for the aroma material to diffuse scent.

In an embodiment, the aroma capsule comprises an air ventilation film that is used to cover the opening of the disposable container and the aroma material contained therein. A sealing cover is further combined above the air ventilation film and the opening of the disposable container to seal the aroma wax in the disposable container. A user can lift the sealing cover and places the aroma capsule in the heat conduction container for the aroma capsule to be heated by the heat generated by the resistor and to diffuse scent. If the aroma diffuser and the aroma wax contained in the disposable container are toppled by chance, the air ventilation film can block the melted aroma wax from flowing out from the aroma diffuser or flowing to the resistor or any space. Therefore, the aroma diffuser is safe to use. In an embodiment, the container is made of metal, and the aroma capsule can be disposed when the aroma wax is evaporated completely. A user does not need to wash the container, and the container will not be broken. It is thus easy to replace the aroma material. In an embodiment, the plugging device is a car plug or a USB device. Therefore, the aroma diffuser can be supplied with power from other sources.

### BRIEF DESCRIPTION OF DRAWINGS

The invention can be more fully understood by reading the following detailed description of the preferred embodiments, with reference made to the accompanying drawings, wherein:

FIG. 1 is a schematic diagram of an aroma diffuser having a variable plugging device using an aroma capsule of an embodiment according to the present invention;

FIG. 2 is an exploded view of the aroma diffuser shown in FIG. 1;

FIG. 3 is a cross-sectional view of the aroma diffuser shown in FIG. 1;

FIG. 4 is a schematic diagram of an aroma diffuser having a variable plugging device using an aroma capsule according to the present invention, wherein the aroma diffuser employs a USB device and a USB male connector; and

FIG. 5 is a schematic diagram of an aroma diffuser having a variable plugging device using an aroma capsule according to the present invention, wherein a car plug having an end portion combined with a USB female connector is provided.

### DETAILED DESCRIPTION OF THE INVENTION

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

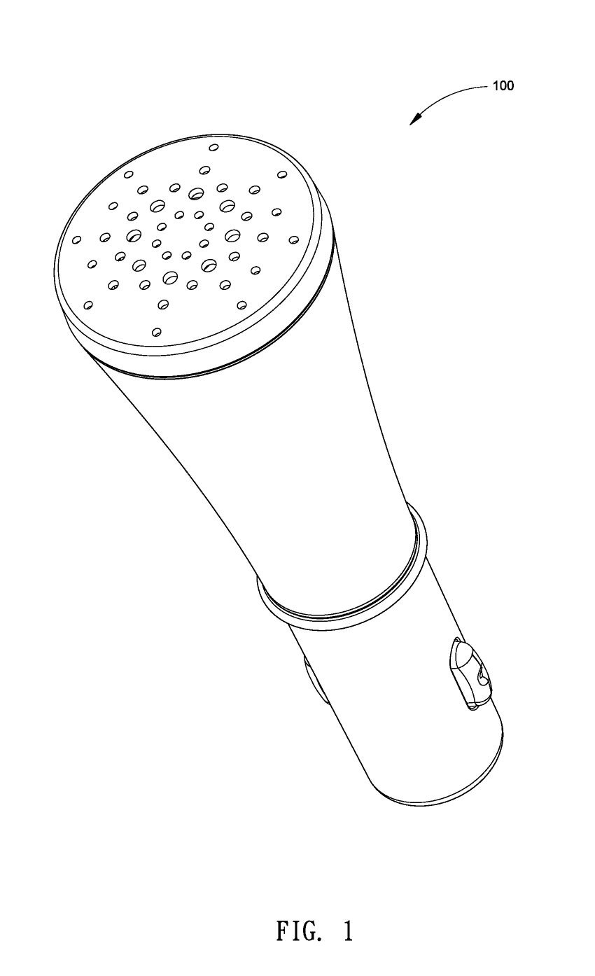

Referring to FIGS. 1-3, an aroma diffuser 100 comprises a hollow housing 1, a heat conduction container 2, a resistor 3, and a plugging device 4. The hollow housing 1 has a first opening 11 and a second opening 13. The heat conduction container 2 is installed in the hollow housing 1 and has a free end 21. The resistor 3 is installed under the heat conduction container 2. The plugging device 4 is installed in the second opening 13 of hollow housing 1 and electrically connected (not shown) to the resistor 3.

The aroma diffuser 100 further comprises an aroma capsule 7 disposed in the heat conduction container 2. The aroma capsule 7 comprises a disposable container 71 and an aroma material 75 placed in the disposable container 71. The disposable container 71 has an opening 711.

When supplied with power, the resistor 3 generates heat, and the heat conduction container 2 conducts the heat to the disposable container 71 and the aroma material 75 for the aroma material 75 to diffuse scent.

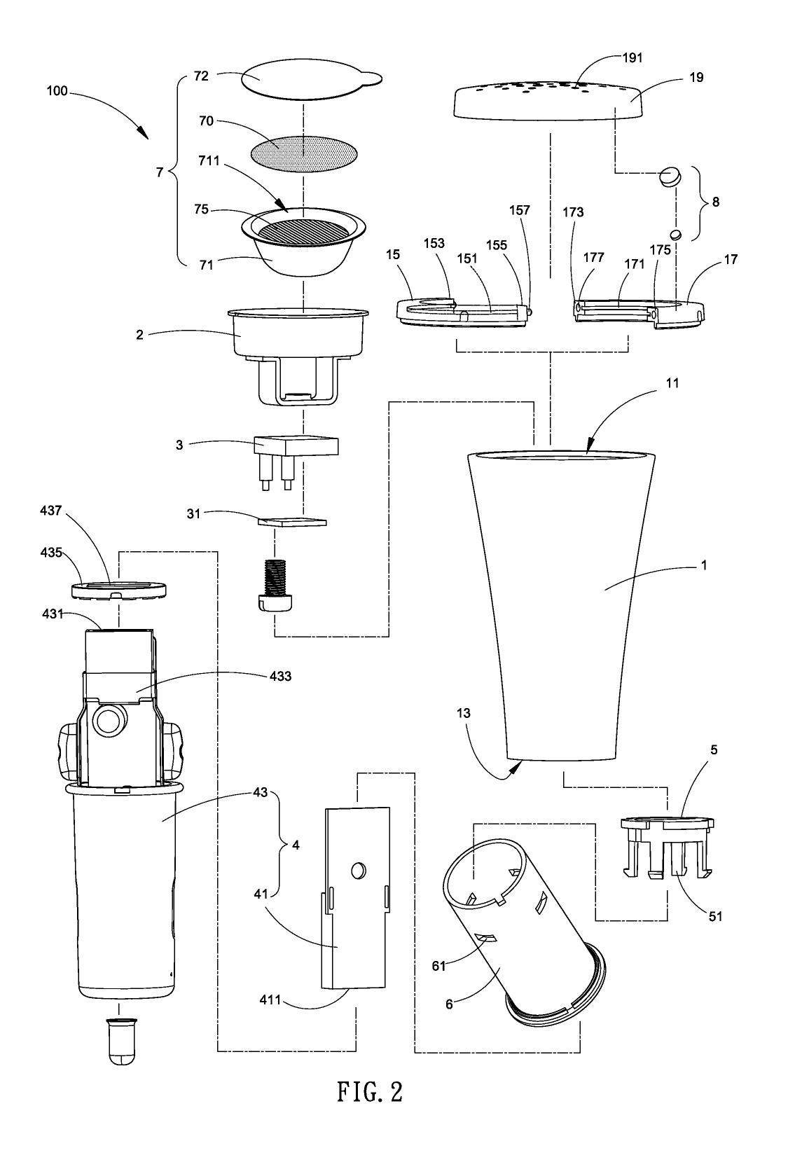

In an embodiment, the aroma capsule 7 further comprises a sealing cover 72 (shown in FIG. 2) combined with the opening 711 of the disposable container 71, for protecting the aroma material 75 (e.g., aroma wax) of the aroma capsule 7 from contamination or loss of scent. A user can lift the sealing cover 72, and place the disposable container 71 of the aroma capsule 7 and the aroma material 75 contained therein at the free end 21 of the heat conduction container 2.

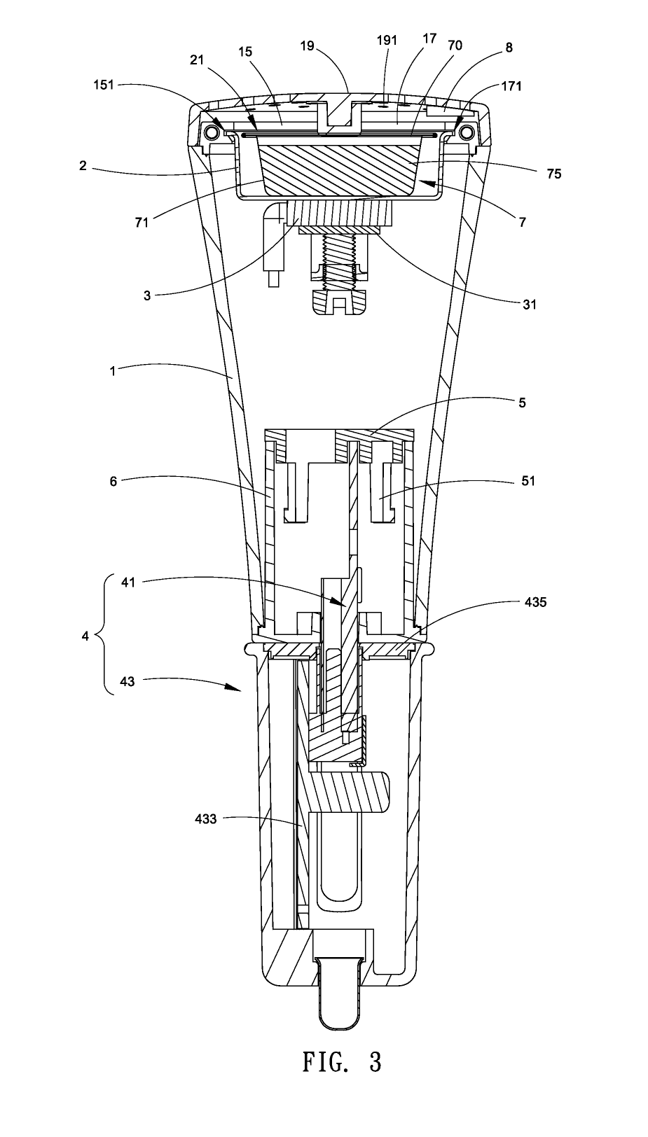

Refer to FIGS. 2 and 3. In a preferable embodiment, the aroma capsule 7 further comprises an air ventilation film 70 combined with the opening 711 of the disposable container 71.

In the above preferable embodiment, the aroma capsule 7 further comprises the sealing cover 72 (shown in FIG. 2). The sealing cover 72 seals the opening 711 and covers the aroma material 75 and the air ventilation film 70. Therefore, the aroma material 75 of the aroma capsule 7 can be protected from contamination or loss of scent.

In an embodiment, the aroma material 75 is aroma wax and essence block.

In general, the aroma material 75 will melt and evaporate to diffuse scent at 35-75° C.. In an embodiment, the aroma material 75 is aroma wax. The resistor 3 only needs to heat the aroma wax up to 35-75° C., and the aroma wax will diffuse scent into the ambient. Correspondingly, the disposable container 71 is made of a material that will not melt or be deform at 35-75° C. and can conduct the heat generated by the resistor 3 to the aroma material 75. In an embodiment, the disposable container 71 is made of metal, hard plastic, a fiber bowl (e.g., plant fiber such as corn fiber, glass fiber, and carbon fiber), or a composite material.

In an embodiment, the disposable container 71 is an aluminum-foiled bowl. Therefore, the disposable container 71 is thin and light and can conduct the heat generated by the resistor 3 to the disposable container 71 and the aroma material 75 effectively. Besides, the aluminum-foiled disposable container 71 is durable, unlike the ceramic bowl or glass contained used by the heating device of the prior art to contain essential oil or aroma wax that is likely to be broken.

Since the aroma material 75 is placed in the disposable container 71, rather than placed in the conventional container, a user, when using the aroma material 75, can lift the sealing cover 72, unlikely to be stained with the aroma material 75. After the aroma material 75 is evaporated completely at the free end 21 of the heat conduction container 2, the user can replace the disposable container 71 that have the aroma material 75 contained therein with a new disposable container that may contain an aroma material that diffuses different scent from the aroma material 75. Therefore, the user does not need to wash the disposable container 71, and will not smell unexpected, mixed scent. Besides, since the disposable container 71 is made of aluminum foil, the user does not need to worry about breaking the disposable container 71 when washing the disposable container 71. No additional contained is needed to contain the aroma material 75.

In an embodiment, the air vents of the air ventilation film 70 guide the scent diffused by the aroma material 75 (aroma wax) to flow upward into the ambient. In an embodiment, the air ventilation film 70 is made of a fabric (e.g., a non-woven fabric, a fiber fabric, linen and canvas), a fiber sheet, a ventilation film or a ventilation metal foil. The user of the aroma capsule 7 can lift the sealing cover 72, and place the disposable container 71 in the heat conduction container 2 to be heated by the heat generated by the resistor 3 to diffuse scent. If the aroma diffuser 100 is toppled by chance, the melted aroma wax contained in the disposable container 71 is blocked by the air ventilation film 70 from flowing to the car or other spaces. Therefore, the aroma diffuser 100 is safe to use.

In an embodiment, referring to FIGS. 1-3, the aroma diffuser 100 further comprises a first hooking ring 15, a second hooking ring 17, a cover 19, a first inner annular groove 151 formed on an inner side of the first hooking ring 15, and a second inner annular groove 171 formed on an inner side of the second hooking ring 17. An outer flange 211 is formed on the free end of the heat conduction container 2, and has one side hooked to the first inner annular groove 151 of the first hooking ring 15 and the other side hooked to the second inner annular groove 171 of the second hooking ring 17. The cover 19 covers and fixes outer peripheries of the first hooking ring 15 and the second hooking ring 17, and comprises air vents 191.

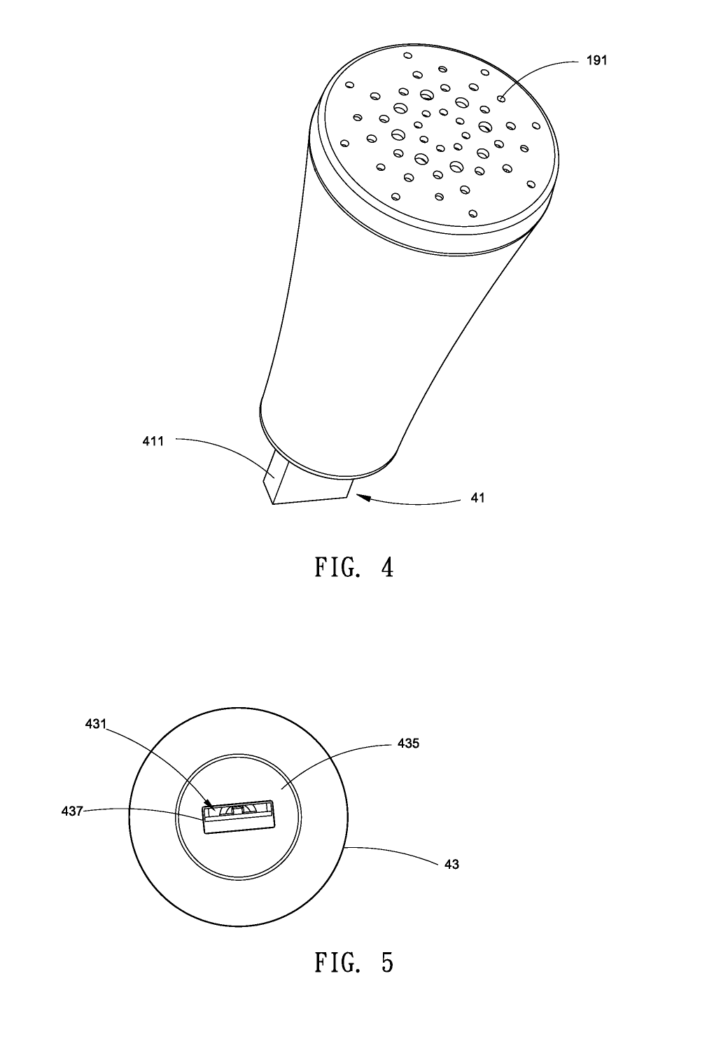

In an embodiment, the aroma diffuser 100 further comprises a pawl 5 and a hollow tail cover 6. The pawl 5 has a plurality of hooking components 51 protruding downward therefrom. The hollow tail cover 6 has a plurality of perforations 61 disposed on a periphery thereof. The pawl 5 is combined with an inner portion of the hollow tail cover 6. The hooking components 51 of the pawl 5 are hooked outward to the perforations 61. The hollow tail cover 6 is combined with an inner side of the second opening 13 of the hollow housing 1. The plugging device 4 comprises a USB device 41 (referring to FIG. 4 at the same time). The USB device 41 has one side combined with the hollow tail cover 6 and the pawl 5 and electrically connected to the resistor 3, and a USB male connector 411 disposed on the other side protruding from the second opening 13 of the hollow housing 1. The USB male connector 411 can be combined with an external USB connection port (e.g., a USB female connector of a mobile device or a computer) that provides power to the resistor 3, and the resistor 3 can generate heat, which will be conducted by the heat conduction container 2 to the disposable container 71 of the aroma capsule 7 and the aroma material 75 (aroma wax) contained in the disposable container 71.

Please refer to FIGS. 2, 4 and 5 at the same time. In an embodiment, the plugging device 4 comprises a car plug 43, and the car plug 43 comprises a USB female connector 431 installed on one end thereof, and a PCB 433 installed inside the car plug 43 and electrically connected to the USB female connector 431. The USB male connector 411 that protrudes from the second opening 13 of the hollow housing 1 is detachably electrically connected to the USB female connector 431 of the car plug 43. When the car plug 43 is not in use, the car plug 43 can be separated from the USB male connector 411 at one side of the USB female connector 431, and the second opening 13 of the hollow housing 1 exposes the USB male connector 411, which can be connected to a USB connection port.

In an embodiment, the PCB 433 supplies power to the resistor 3 intermittently, and the aroma diffuser 100 that uses the aroma capsule 7 diffuses scent intermittently.

Please refer to FIGS. 2 and 3. The car plug 43 further comprises an interface cover 435. The interface cover 435 has a through hole 437 formed at a center thereof. The interface cover 435 corresponds to the USB female connector and is connected to one end of the car plug 43.

In an embodiment, the plugging device 4 is the USB device 41 (referring to FIG. 4) or the car plug 43 (referring to FIG. 1). The USB device 41 is electrically connected to the resistor 3. The USB male connector 411 of the USB device 41 can be electrically connected to a USB female connector of a mobile device or a computer (not shown). The car plug 43 can be electrically connected to the resistor 3. The car plug 43 is plugged into an in-car electrical connector.

In an embodiment, the bottom portion of the resistor 3 is further combined with a washer 31, as shown in FIGS. 2 and 3.

In an embodiment, the first hooking ring 15 comprises a first end portion 153 and a second end portion 155, one of which comprises a protruding tenon 157, and the second hooking ring 17 comprises a first end portion 173 and a second end portion 175, one of which comprises a mortise 177 that can be combined with the tenon 157.

In an embodiment, the heat conduction container 5 and the aroma capsule 7 have matched sizes and shapes, in order for the aroma capsule 7 to be contained in the heat conduction container 5 and the heat conductive container 5 to conduct heat to the aroma capsule 7 effectively.

In an embodiment, the car plug 43 can be combined with an aroma material and used in a car. In an embodiment, the USB device 41 can be used in a mobile device, a notebook computer, a desktop computer and any appliance that has a USB connection port. Therefore, a user can use the aroma diffuser with a variety of plugging devices. A user is allowed to lift the sealing cover 72, and place the aroma capsule in the heat conduction container 2. The aroma diffuser 100 of the present invention can be safely used in a car or used by a mobile device or a notebook computer that has a USB connection port.

In an embodiment, the cover 19 and the first hooking ring 15 or second hooking ring 17 can be combined with magnets 8 such that the magnets 8 attract one another and the cover 19 can cover and be fixed to the first hooking ring 15 or the second hooking ring 17. Therefore, the cover 19 can cover the first hooking ring 15 or the second hooking ring and the first opening 11 of the hollow housing 1 easily.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. An aroma diffuser, comprising:
a diffuser including a hollow housing, a heat conduction container, a resistor, and a plugging device, wherein the hollow housing has a first opening and a second opening, the heat conduction container is received in the hollow housing and has a free end, the resistor is disposed under the heat conduction container, and the plugging device is installed in the second opening of the hollow housing and electrically connected to the resistor; and
an aroma capsule disposed in the heat conduction container and comprising a disposable container and an aroma material disposed in the disposable container, the disposable container having an opening,
wherein the resistor, when supplied with power, generates heat, and the heat conduction container conducts the heat to the disposable container and the aroma material for the aroma material to diffuse scent.

2. The aroma diffuser of claim 1, wherein the aroma capsule further comprises an air ventilation film combined with the opening of the disposable container.

3. The aroma diffuser of claim 2, wherein the air ventilation film is made of a fabric, a fiber sheet, an air ventilation film or an air ventilation metal foil.

4. The aroma diffuser of claim 1, wherein the aroma material is aroma wax .

5. The aroma diffuser of claim 1, wherein the disposable container is made of metal, hard plastic, fiber bowl or a composite material.

6. The aroma diffuser of claim 5, wherein the disposable container is made of metal, and the metal disposable container is an aluminum foil bowl.

7. The aroma diffuser of claim 1, wherein the diffuser further comprises a first hooking ring, a second hooking ring, a cover, a first inner annular groove formed in an inner side of the first hooking ring, and a second inner annular groove formed in an inner side of the second hooking ring, the heat conduction container has an outer flange disposed on the free end and having one side hooked to the first inner annular groove of the first hooking ring and the other side hooked to the second inner annular groove of the second hooking ring, and the cover has air vents and covers and fixes outer peripheries of the first hooking ring and the second hooking ring.

8. The aroma diffuser of claim 7, wherein the cover and the first hooking ring or the second hooking ring are combined with magnets such that the magnets attract one another and the cover is fixed to the first hooking ring or the second hooking ring.

9. The aroma diffuser of claim 1, wherein the diffuser further comprises a hollow tail cover having a plurality of perforations installed on a periphery thereof and a pawl having a plurality of hooking components extending downward therefrom and combined with an inner portion of the hollow tail cover, and the plugging device comprises a USB device, one side of which is combined in the hollow tail cover and the pawl and electrically connected to the resistor, the USB device having a USB male connector disposed on other side thereof that protrudes from the second opening of the hollow housing.

10. The aroma diffuser of claim 9, wherein the plugging device further comprises a car plug having a PCB installed inside the car plug and a USB female connector connected to one end of the car plug and electrically connected to the PCB, and the USB male connector protruding from the second opening of the hollow housing is detachably electrically connected to the USB female connector of the car plug, such that the car plug can be separated from the USB male connector from one end of the USB female connector when the car plug is not in use and the USB male connector is exposed from the second opening of the hollow housing for use as a USB connection port.

11. The aroma diffuser of claim 10, wherein the car plug comprises an interface cover having a through hole formed at a center thereof, the interface cover corresponding to the USB female connector and connected to one end of the car plug.

12. The aroma diffuser of claim 9, wherein the first hooking ring comprises a first end portion and a second end portion, one of which is provided with a protruding tenon, and the second hooking ring comprises a first end portion and a second end portion, one of which is provided with a mortise that is combined with the tenon.

13. The aroma diffuser of claim 1, wherein the plugging device is a USB device or a car plug.

14. The aroma diffuser of claim 1, further comprises a washer combined with a bottom portion of the resistor.
